(19) United States
(12) Patent Application Publication
(10) Pub. No.: US 2003/0066318 A1
(43) Pub. Date: Apr. 10, 2003

(54) Removable lining for soft circular restraints apparatus and method

(76) Inventor: Bruce Chapman, Gardiner, NY (US)

Correspondence Address: Edward Etkin, Esq., Suite 3C, 4804 Bedford Avenue, Brooklyn, NY, 11235, US

(21) Appl. No.: 10/266,015

(22) Filed: Oct. 7, 2002

Related U.S. Application Data
(60) Provisional application No. 60/327,670, filed on Oct. 6, 2001.

(51) Int. Cl. E05B 15/00

(52) U.S. Cl. 70/1

(57) ABSTRACT

A removable lining apparatus and method usable in conjunction with a soft mechanical restraint cuff is disclosed. The inventive removable lining ensures sanitary conditions during the utilization of the restraint cuff and reduces the wear and tear thereto. Embodiments of the inventive removable lining include a friction coating on the side that contacts the restrained person's limb, a one- and two-part releasable attachment systems for releasably attaching the inventive lining to a restraint cuff, and a disposable absorbent removable lining.

### REFERENCE TO PREVIOUSLY FILED APPLICATIONS

The present patent application claims priority from a previously filed commonly assigned U.S. Provisional Patent Application Serial No.: 60/327,670, entitled “Soft Circular Restraint with Removable Lining Apparatus and Method” filed on Oct. 6, 2001.

### BACKGROUND OF THE INVENTION

The present invention is directed to a removable lining apparatus usable in conjunction with a soft mechanical restraint system that may be easily and quickly deployed by a first person on a subject being held in a restrained position by a second person, where the removable lining ensures sanitary conditions during the utilization of the restraint system and reduces the wear and tear thereto.

There are many thousands of human service and law enforcement agencies and facilities that provide care and supervision to aggressive, suicidal, and emotionally disturbed persons (hereinafter commonly referred to as “EDPs”). The staff and officers working in these agencies regularly come into physical contact with the EDPs through the use of physical subduing or restraint holds when the EDP becomes aggressive. Although there are many types of well-known physical subduing holds, the safest and most advantageous physical subduing hold is a Primary Restraint Technique (PRT) described in greater detail in a commonly assigned co-pending U.S. patent application entitled “APPARATUS AND METHOD FOR SAFELY MAINTAINING A RESTRAINING HOLD ON A PERSON”.

While restraint holds are useful for relatively short periods of time, often restraint of the EDP is necessary for an extended period of time. In such cases, the EDP must be restrained using some sort of a mechanical restraint system. Typically, this involves placing wrist and ankle restraints on the EDP so that the EDP may be restrained for an extended period of time at the place of the restraint hold, or, transported to another location while wearing the restraints. Also, for extended restraints, special beds with integrated restraints are used in many facilities. Previously known restraint systems involve mechanical locks—for example, the popular Posey TAT restraint utilizes a mechanical spring-loaded lock that require a special key to open. It takes at least 4-5 staff members to successfully apply such restraints at a speed of no lower than 2-3 minutes per restraint. During application of the restraints, the EDP must be held down and poses a constant threat to the staff members until the restraining process is complete. Furthermore, removal of such restraints in emergency situations (i.e., in a medical emergency) takes a significant amount of time since a key must be located and used to open each restraint on each limb—this is especially problematic because without the key, which may not be immediately available in case of an emergency, the restraints cannot be removed at all. Manipulation of the restraints once attached is difficult as well requiring several people to pull webbing through a complex system of buckles and connectors. Another problem that often arises, is that a bed with integrated mechanical restraints for restraining the EDP for extended periods of time may not be available when necessary, thus forcing the staff members to find alternate long-term restraint means. Finally, complex previously known restraint systems are expensive, heavy, and require extensive training to use properly. This is especially true of beds with integrated restraint systems.

The co-pending commonly assigned patent application entitled “Soft Circular Restraint Apparatus and Method” advantageously solves all of the above problems, and is hereby incorporated by reference in its entirety. However, one issue remains unsolved. In many cases, EDPs may have blood on their limbs due to self-inflicted wounds, from wounds inflicted by another EDP, or as a result of a struggle with staff members. Due to the absorbent nature of the typical restraints blood may stain or become absorbed by the restraints posing a significant health hazard to anyone else using the restraints later. Most importantly, during ordinary use of limb restraints, sweat or other bodily fluids may also come into contact with the inner portion of the restraints, As a result, the restraints must be washed and sterilized carefully after each use. However, this practice causes restraints to become slightly more worn out with each sterilization/wash, thus shortening their useful lifetime. Finally, the restraints are out of service during the time of sterilization so duplicate restraint sets must be kept to be available when necessary.

Thus, it would be desirable to provide an apparatus and method for reducing the need to sterilize/wash limb restraints after each use. It would further be desirable to provide an apparatus and method for providing an absorbent lining for limb restraints.

### SUMMARY OF THE INVENTION

The apparatus of the present invention, and method of use thereof, remedies the problems and challenges associated with sterilizing and cleaning mechanical limb restraint cuffs after each use. In brief summary, the inventive removable restraint lining apparatus advantageously provides: (1) quick and easy removal from the restraint cuff after use and replacement with another lining; (2) easily washable/easy to sterilized without deterioration of the quality of the restraint cuff; (3) increases the friction of the restraint cuff's inner surface with EDP's limbs; and (4) in an alternate embodiment, provides an absorbent surface to soak fluids (such as blood, etc.), and configured as disposable, and capable of being used with any restraint cuff without modification.

In the first embodiment of the present invention, the removable restraint lining includes an elongated flat webbing body, having padding with an optional friction coating on one side (for contact with an EDP's limb) along one surface, and a releasable attachment material along the other surface. The padding coating may include friction material and/or absorbent material. An optional tab is provided at one end to facilitate removal of the lining from a restraint cuff after use. The releasable material may be one of hook or loop material, provided at least a portion of the restraint cuff used in conjunction therewith is provided with the other of hook or loop material for releasable connection of the lining thereto. Optionally, if the restraint cuff is not provided with any releasable attachment material that matches the material on the inventive removable lining, the removable lining may be provided with an alternate releasable attachment material such as a reusable temporary adhesive strip. In another embodiment of the present invention, the removable lining is disposable. In this embodiment, the flat webbing body is replaced with an elongated absorbent pad for contact with the EDP's limb. The absorbent pad is provided with a releasable attachment material strip on one surface for releasably attaching to the inner surface of the restraint cuff. As before, the material strip may be hook or loop, if the inner surface of the restraint cuff is provided with a corresponding material strip, or it may be releasable adhesive or the like.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein like reference characters denote corresponding or similar elements throughout the various figures:

FIG. 1 shows a side view of a first embodiment of the inventive removable restraint lining of the present invention in a deployed position;

FIG. 2 shows a side view of a second embodiment of the inventive removable restraint lining of the present invention in a deployed position;

FIG. 3 shows a side view of a circular limb restraint cuff utilizing the inventive removable restraint lining of FIG. 1 in a fully deployed position; and

FIG. 4 shows an isometric view of the circular limb restraint cuff utilizing the inventive removable lining of FIG. 1 in a partially deployed position.

### DESCRIPTION OF THE PREFERRED EMBODIMENTS

The present invention relates to an advantageous removable lining for soft mechanical restraints that may be quickly and easily removed after use such that only the lining needs to be sterilized and cleaned rather than the entire restraint, in order to reduce the wear and tear to the restraints and to facilitate re-use of the restraints with a simple replacement of removable liners.

There are many thousands of human service and law enforcement agencies and facilities that provide care and supervision to aggressive, suicidal, and emotionally disturbed persons (hereinafter commonly referred to as “EDPs”). The staff and officers working in these agencies regularly come into physical contact with the EDPs through the use of physical subduing or restraint holds when the EDP becomes aggressive. Although there are many types of well-known physical subduing holds, the safest and most advantageous physical subduing hold is a Primary Restraint Technique (PRT) described in greater detail in a commonly assigned co-pending U.S. patent application entitled “APPARATUS AND METHOD FOR SAFELY MAINTAINING A RESTRAINING HOLD ON A PERSON” which is hereby incorporated by reference in its entirety.

While restraint holds are useful for relatively short periods of time, often restraint of the EDP is necessary for an extended period. In such cases, the EDP must be restrained using some sort of a mechanical restraint system. Typically, this involves placing wrist and ankle (hereinafter “cuff”) restraints on the EDP so that the EDP may be restrained for an extended period of time at the place of the restraint hold, or transported to another location while wearing the restraints.

During and subsequent to application of cuff restraints, EDPs may have blood on their limbs due to self-inflicted wounds; from wounds inflicted by another EDP, or as a result of a struggle with staff members. Due to the absorbent nature of the typical restraints blood may stain or become absorbed by the restraints posing a significant health hazard to anyone else using the restraints later. Most importantly, during ordinary use of cuff restraints, sweat or other bodily fluids may also come into contact with the inner portion of the restraints.

The essence of the invention is that a removable lining is provided for cuff restraints (such as the restraints disclosed in the above-incorporated “Soft Circular Restraint Apparatus and Method” patent application). Depending on its configuration, the inventive lining either repels or absorbs bodily fluids coming into contact with the inner surface of the cuff restraint. After use, the inventive lining may be readily removed for sterilization/washing (or disposal) and a new lining may be deployed in the cuff restraint without taking the restraint out of service or causing deterioration thereof.

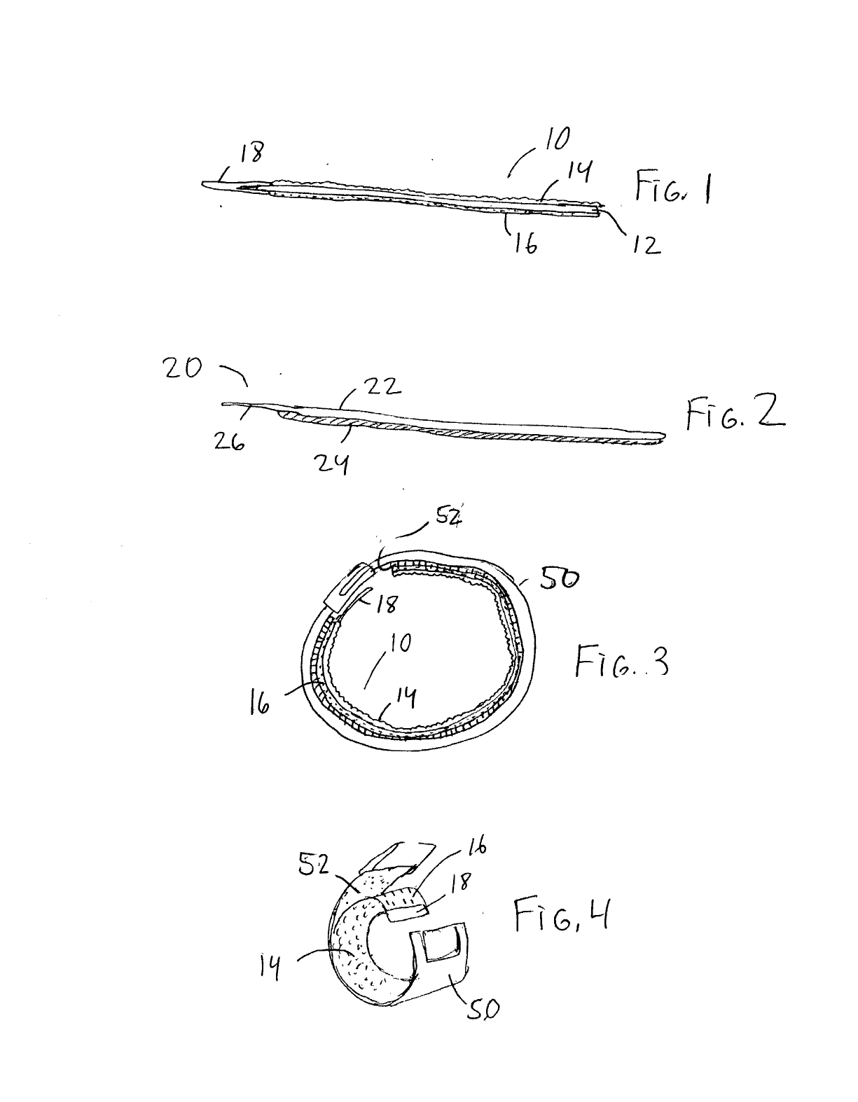

Referring now to FIGS. 1, 3, and 4 a first embodiment of the inventive removable restraint liner is shown as a removable liner 10 used in conjunction with a cuff restraint 50. The liner 10 includes: a flat elongated webbing body 12 sized and configured to fit within a typical cuff restraint 50, an elongated padding element 14 disposed along at least a portion of the top surface of body 12, a releasable attachment element 16 disposed along at least a portion of the bottom surface of body 12 for releasably attaching the liner 10 to an inner surface of the cuff restraint 50, and an optional tab 18 disposed at one end of the body 12 for facilitating removal of the liner 10 from the cuff restraint 50. The tab 18 may be composed of any material. For example, it may be composed of a piece of synthetic webbing or of plastic.

The webbing body 12, may be of any synthetic or other flexible material (such as nylon webbing). The elongated padding element 14 may be any resilient material such as rubber, plastic, or rubberized synthetic material. Optionally, the padding element 14 may include a non-skid friction coating to improve the gripping characteristic of the cuff restraint 50 used therewith. As a matter of design choice the elongated padding element 14 may be non-absorbent to repel body fluids from its surface, or, optionally the padding element 14 may include absorbent material to absorb any body fluids coming into contact therewith.

The releasable attachment element 16 may be one of hook or loop material, provided that the inner surface of the cuff restraint 50 is at least partially covered with a corresponding hook or loop material attachment element 52. The cuff restraint 50 may be pre-configured with a hook or loop element 52 (such as the restraints disclosed in the above-incorporated “Soft Circular Restraint Apparatus and Method” patent application), or the element 52 may be applied to any existing soft cuff restraint (for example by gluing it to the inner surface of the cuff 50.

Optionally, the releasable attachment element 16 may be any other releasable attachment device such as snap buttons (with corresponding buttons on the inner surface of the cuff 50 (not shown), or it may be a reusable, releasable adhesive strip. The liner 10 is shown in a fully deployed position within the cuff 50 in FIG. 3 and in a partially deployed position in FIG. 4.

After use, the lining 10 is readily removed from the cuff restraint 50 and washed/sterilized without subjecting the restraint 50 to deterioration, and allowing the restraint 50 to continue to be utilized (with a different clean lining).

Referring now to FIG. 2, an alternate embodiment of the inventive removable restraint lining is shown as disposable lining 20. The lining 20 includes: a flat elongated body 22 sized and configured to fit within a typical cuff restraint 50, a releasable attachment element 24 disposed along at least a portion of the bottom surface of body 22 for releasably attaching the liner 20 to an inner surface of the cuff restraint 50, and an optional tab 26 disposed at one end of the body 22 for facilitating removal of the liner 20 from the cuff restraint 50. The tab 26 may be composed of any material. For example, it may be composed of a piece of synthetic webbing, cardboard, paper, or plastic. Preferably, all elements of the disposable liner 20 are inexpensive components to lower the fabrication cost.

The body 22, may be of any synthetic or other flexible material (such as cotton or paper) and may include optional padding and/or a non-skid friction coating to improve the gripping characteristic of the cuff restraint 50 used therewith. As a matter of design choice the body 22 may be non-absorbent to repel body fluids from its surface, or, optionally it may include absorbent material to absorb any body fluids coming into contact therewith.

The releasable attachment element 24 is preferably a releasable adhesive strip but it may be may be one of hook or loop material, provided that the inner surface of the cuff restraint 50 is at least partially covered with a corresponding hook or loop material attachment element 52. The cuff restraint 50 may be pre-configured with a hook or loop element 52 (such as the restraints disclosed in the above-incorporated “Soft Circular Restraint Apparatus and Method” patent application), or the element 52 may be applied to any existing soft cuff restraint (for example by gluing it to the inner surface of the cuff 50. Optionally, the releasable attachment element 24 may be any other releasable attachment device such as snap buttons (with corresponding buttons on the inner surface of the cuff 50 (not shown).

The advantage of the disposable liner 20 is that it does not require sterilization or washing and may be disposed of immediately after use.

It should be noted that while the various embodiments of the inventive restraint liners 10, 20 are described as being readily useable with the soft circular restraints disclosed in the above-incorporated “Soft Circular Restraint Apparatus and Method” patent application, as a matter of design choice, the inventive removable liners 10, 20 may be advantageously utilized with any soft limb restraint system.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention.

I claim:

1. A removable lining apparatus for use in conjunction with a limb cuff restraint having an inner surface oriented for contact with a restrained person's limb, the lining apparatus comprising:
a flat flexible elongated body, having a first end, a top surface and a bottom surface, said body being sized and configured to substantially match at least a portion of the inner surface of the cuff restraint; and
releasable attachment means, disposed on said top surface for releasably securing said body to the inner surface of the cuff restraint, thus providing a removable restraint liner.

2. The apparatus of claim 1, further comprising:
a flat contact element disposed along at least a portion of said top surface of said body, wherein when said body is releasably attached to the cuff restraint, said contact element is placed into direct contact with the person's limb.

3. The apparatus of claim 2, wherein said contact element further comprises resilient padding sized and configured to increase the restrained person's comfort.

4. The apparatus of claim 2, wherein said contact element further comprises a friction coating sized and configured to increase friction between said contact element and the restrained person's limb.

5. The apparatus of claim 2, wherein said contact element and said body are formed as a unitary member.

6. The apparatus of claim 1, further comprising a tab positioned at said first end of said body, operable to facilitate quick removal of said body from the cuff restraint after use thereof.

7. The apparatus of claim 1, wherein said body is composed of a flexible resilient material.

8. The apparatus of claim 7, wherein said flexible resilient material is synthetic webbing.

9. The apparatus of claim 1, wherein said releasable attachment means comprise a first strip of one of a hook material and a loop material disposed on said top surface of said body and a second strip of the other of the hook and loop material disposed along at least a portion of the inner surface of the cuff restraint.

10. The apparatus of claim 1, wherein said releasable attachment means comprise a first plurality of button clasps disposed on said top surface of said body and a second plurality of corresponding button clasps disposed along at least a portion of the inner surface of the cuff restraint.

11. The apparatus of claim 1, wherein said releasable attachment means comprises a strip of releasable adhesive disposed on said top surface of said body sized and configured for releasable contact with at least a portion of the inner surface of the cuff restraint.

12. The apparatus of claim 1, wherein said body is comprised of a disposable material.

13. The apparatus of claim 2, wherein said contact element is comprised of a fluid absorbing material.

14. The apparatus of claim 1, wherein said contact element is comprised of a fluid repelling material.

15. A method of providing a removable lining for a limb cuff restraint having an inner surface oriented for contact with a restrained person's limb, comprising the steps of:
(a) providing a flat flexible elongated body, having a first end, a top surface and a bottom surface, said body being sized and configured to substantially match at least a portion of the inner surface of the cuff restraint; and
(b) releasably securing said body to the inner surface of the cuff restraint, thus providing a removable restraint liner.
